(19) United States
(12) Patent Application Publication
(10) Pub. No.: US 2009/0177919 A1
(43) Pub. Date: Jul. 9, 2009

(54) DYNAMIC REDUNDANCY FOR MICROPROCESSOR COMPONENTS AND CIRCUITS PLACED IN NONOPERATIONAL MODES

(75) Inventors: Pradip Bose, Yorktown Heights, NY (US); Jeonghee Shin, Los Angeles, CA (US); Victor Zyuban, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/969,436

(22) Filed: Jan. 4, 2008

(51) Int. Cl. G06F 11/20

(52) U.S. Cl. 714/10; 714/E11.072

(57) ABSTRACT

An apparatus for implementing dynamic redundancy for a microprocessor system includes a plurality of microprocessor components, each of which is capable of being selectively placed in a non-operational mode while one or more other of the microprocessor components remain in an operational mode, and then subsequently restored from the non-operational mode back to the operational mode, the spare microprocessor component configured to be switched from the non-operational mode to the operational mode whenever one of the plurality of the microprocessor components is placed in the non-operational mode, and wherein the spare microprocessor component is configured to be switched back to the non-operational mode whenever each of the microprocessor components are in the operational mode; and multiplexing circuitry configured to map the use of the microprocessor components and the spare microprocessor component with respect to the operational mode and the non-operational mode.

### BACKGROUND

The present invention relates generally to improvements in lifetime reliability of semiconductor devices and, more particularly, to a dynamic redundancy method and apparatus for microprocessor components and circuits selectively placed in non-operational modes.

Lifetime reliability has become one of the major concerns in microprocessor architectures implemented with deep submicron technologies. In particular, extreme scaling resulting in atomic-range dimensions, inter and intra-device variability, and escalating power densities have all contributed to this concern. At the device and circuit levels, many reliability models have been proposed and empirically validated by academia and industry. As such, the basic mechanisms of failures at a low level have been fairly well understood, and thus the models at that level have gained widespread acceptance. In particular, work lifetime reliability models for use with single-core architecture-level, cycle-accurate simulators have been introduced. Such models have focused on certain major failure mechanisms including, for example, electromigration (EM), negative bias temperature instability (NBTI), positive bias temperature instability (PBTI), and time dependent dielectric breakdown (TDDB).

With respect to improving lifetime reliability of semiconductor devices, existing efforts may be grouped into three general categories: sparing techniques, graceful degradation techniques, and voltage/frequency scaling techniques. In sparing techniques, spare resources are designed for one or more primary resources and deactivated at system deployment. When primary resources fail later during system lifetime, the spare resources are then activated and replace the failed resources in order to extend system lifetime. The sparing techniques cause less performance degradation due to failed resources. However, high area overhead of spare resources is a primary drawback of this approach.

In graceful degradation techniques, spare resources are not essential in order to extend system lifetime. Instead, when resource failing occurs, systems are reconfigured in such a way so as to isolate the failed resources from the systems and continue to be functional. As a result, graceful degradation techniques save overhead cost for spare resources, however system performance degrades throughout lifetime. Accordingly, graceful degradation techniques are limited to applications and businesses where the degradation of performance over time is acceptable, which unfortunately excludes most of the high-end computing.

Thirdly, voltage/frequency scaling techniques are often used for power and temperature reduction and are thus proposed for lifetime extension. The system lifetime is predicted based on applied workloads and the voltage/frequency of the systems is scaled with respect to lifetime prediction. While voltage/frequency scaling techniques enable aging of systems to be slowed down as needed, these techniques also result in performance degradation of the significant parts of the system or the entire systems. In addition, although reduced voltage/frequency diminishes the degree of stress conditions, these techniques are unable to actually remove stress conditions of aging mechanisms from semiconductor devices.

Still another existing technique, directed to reducing the leakage power during inactive intervals, is to use so-called “sleep” or “power down” modes for logic devices that are complemented with transistors that serve as a footer or a header to cut leakage during the quiescence intervals. During a normal operation mode, the circuits achieve high performance, resulting from the use of faster transistors which typically have higher leakage. The headers and/or footers are activated so as to couple the circuits to V_{dd} and/or ground (more generally logic high and low voltage supply rails). In contrast, during the sleep mode, the high threshold footer or header transistors are deactivated to cut off leakage paths, thereby reducing the leakage currents by orders of magnitude. This technique, also known as “power gating,” has been successfully used in embedded devices, such as systems on a chip (SOC). However, although power gating diminishes current flow and electric field across semiconductor devices (which results in a certain degree of stress reduction and increase in the lifetime of devices), it is unable to completely eliminate such stress conditions and/or stimulate the recovery effects of aging mechanisms.

### SUMMARY

The foregoing discussed drawbacks and deficiencies of the prior art are overcome or alleviated, in an exemplary embodiment, by an apparatus for implementing dynamic redundancy for a microprocessor system, including a plurality of microprocessor components, each of which is capable of being selectively placed in a non-operational mode while one or more other of the microprocessor components remain in an operational mode, and then subsequently restored from the non-operational mode back to the operational mode, wherein the operational mode comprises the performance of one or more tasks for which the microprocessor component is designed to execute with respect to the microprocessor system; a spare microprocessor component, the spare microprocessor component configured to be switched from the non-operational mode to the operational mode whenever one of the plurality of the microprocessor components is placed in the non-operational mode, and wherein the spare microprocessor component is configured to be switched back to the non-operational mode whenever each of the microprocessor components are in the operational mode; and multiplexing circuitry configured to map the use of the microprocessor components and the spare microprocessor component with respect to the operational mode and the non-operational mode.

### BRIEF DESCRIPTION OF THE DRAWINGS

Referring to the exemplary drawings wherein like elements are numbered alike in the several Figures:

FIG. 1 is a schematic diagram of an exemplary memory array structure incorporating a built-in redundancy feature to dynamically replace elements selectively placed in a non-operational mode of operation, in accordance with an exemplary embodiment of the invention;

FIG. 2 is a schematic diagram of an alternative embodiment of the array structure of FIG. 1, further incorporating a data migration feature;

FIG. 3 is a schematic diagram of an alternative embodiment of the array structure of FIG. 2;

FIG. 4 is a schematic block diagram of an exemplary control scheme for sequencing individual arrays placed in the non-operational mode of operation.

### DETAILED DESCRIPTION

Disclosed herein is a dynamic redundancy method and apparatus for microprocessor components and circuits selectively placed in “non-operational” modes. Such non-operational modes may include, for example, special lifetime extension methods for suspending and/or reversing the aging of resources. That is, rather than using the resources for their intended purpose, components (e.g., transistors) of such resources are temporarily subjected to a mode in which stress conditions of aging mechanisms, such as electromigration, negative bias temperature instability (NBTI), positive bias temperature instability (PBTI), and time dependent dielectric breakdown (TDDB), are removed and/or reversed with respect to the semiconductor devices comprising the resources. Additional information regarding aging mechanism removal (termed “wearout gating”) and aging mechanism reversal (termed “intense recovery”) may be found in co-pending application Ser. Nos. 11/928,232 and 11/928,205, respectively, both filed on Oct. 30, 2007, assigned to the assignee of the present application, and the contents of which are incorporated herein by reference.

As opposed to conventional sparing techniques, a spare device (e.g., an SRAM array) is used to temporarily replace a regular SRAM array that has been selectively placed in a non-operational mode for a purpose such as lifetime extension treatment. However, once the regular array has completed the treatment (or more generally, once the regular array is ready to be placed back into an operational mode) and resume its normal duties, the spare array may either revert back to a spare status or continue to function as a replacement for a different array that is to be placed in a non-operational mode. Therefore, while a non-operational mode could represent a permanent condition (such as a defect or malfunction), it could also represent a temporary condition by which the resource is subsequently restored to a fully operational state. In contrast, an “operational mode” as used herein generally refers to a task or tasks for which a microprocessor component is designed to execute with respect to a microprocessor system.

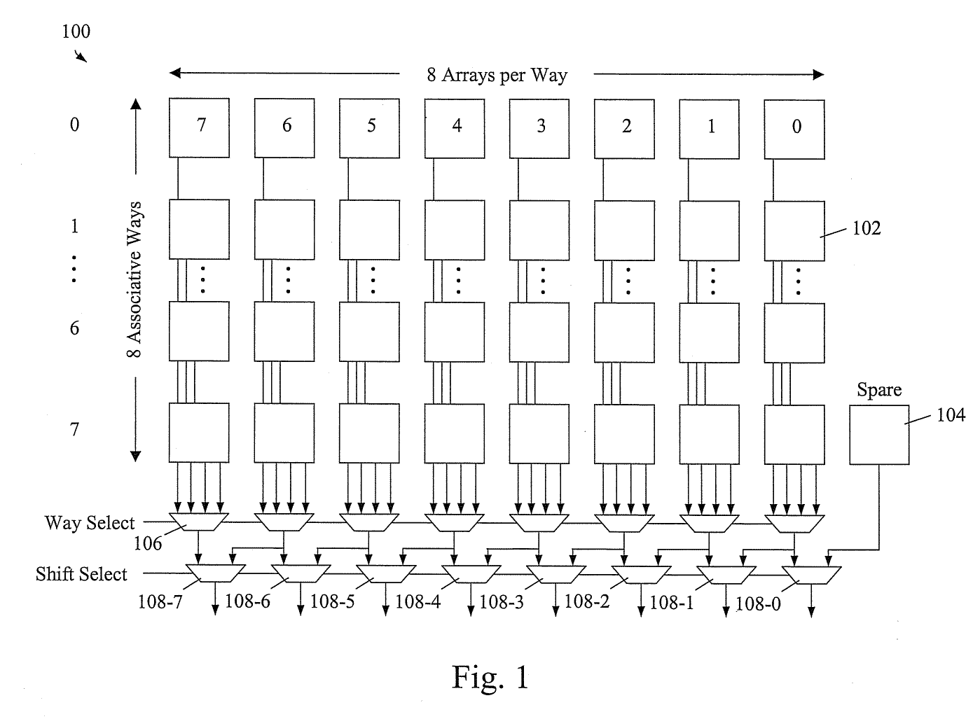

Referring initially to FIG. 1, there is shown a schematic diagram of an exemplary memory array structure 100 for use by microprocessor systems, which incorporates a built-in redundancy feature to dynamically replace elements selectively placed in a non-operational mode of operation, in accordance with an exemplary embodiment of the invention. More specifically, the exemplary array structure 100 of FIG. 1 depicts an 8-way set-associative cache having a total of 64 individual SRAM arrays 102. Within each row of the structure 100, eight of the arrays 102 define one associative way. However, it will be appreciated that a different number of arrays, as well as a structure with a different set-associativity could also be used. Moreover, the principles of the embodiments described herein may be applied to various granularities of caches, such as the entire cache, banks, ways, arrays, columns and rows. In the exemplary memory structure 100 of FIG. 1, one array 102 is configured to enter a non-operational mode (e.g., wearout gating, intense recovery) at a time.

When an array or group of arrays enters a non-operational mode, the data stored therein should be appropriately handled in order to maintain system integrity. This handling or management of data from an array placed in a non-operational mode is also referred to herein as a “drain” process. In the drain process, cache lines in valid states such as shared, dirty or exclusive state need to be written back to the lower level of the memory hierarchy and/or cache lines stored in the upper level of the hierarchy need to be invalidated if the inclusion property needs to be held. As used herein, this drain process is also referred to an invalidation mechanism.

Accordingly, FIG. 1 illustrates an invalidation mechanism in which one array enters a non-operational mode at a time and, accordingly, there is a spare array 104 associated with the memory structure 100. In addition, a first level of multiplexing (as depicted by multiplexers 106) is used to select which one of the 8-ways is to be accessed during a memory operation (e.g., read). This way selection is controlled through a first control signal, labeled “Way Select” in FIG. 1. Furthermore, when one of the arrays 102 (numbered 0 through 7, from right to left) of a given way is in a non-operational mode, the spare array 104 is used so long as that array remains in the non-operational mode.

To this end, a second level of multiplexing (as depicted by multiplexers 108-0 through 108-7) is used as a shift mechanism to control whether a nominal output of a corresponding multiplexer 106 is used, or whether a shifted output is used (meaning that the spare array 104 is in use as part of the row selected by the first multiplexer 106). The individual multiplexers 108-0 through 108-7 are controlled by a corresponding bit of a multiple bit control signal, labeled “Shift Select” in FIG. 1. When an array located in column n (where “n” is from 0 to 7 as shown) for a given way is placed in a non-operational mode, the multiplexer corresponding to column n (i.e., 108-n) selects the right side input (i.e., the shifted input), as does each multiplexer to the right of column n whenever when the row is selected that contains the array that is currently in the non-operational mode. For accesses to all other rows, all multiplexers 108 select the left input (i.e., the non-shifted input). On the other hand, each multiplexer to the left of column n selects the left side input (i.e., the nominal input).

For example, it is assumed that that array 4 of way 0 is entering a non-operational mode, such as an anti-aging process for lifetime extension. First, all valid cache lines of array 4 are invalidated so as cause write-back to the lower level (not shown) of the memory hierarchy and invalidation of cache lines in the upper level (not shown) of the memory hierarchy. If cache lines are interleaved among arrays, this invalidation process causes the entire way to be invalidated. Depending on the architectural organization of the caches, the write-back to the lower level of the memory hierarchy may be needed only for modified lines or for all valid lines.

Once this invalidation process is completed, array 4 enters the non-operational mode and the spare array 104 enters a normal operation mode in order to replace array 0. From this point, the spare array 104, arrays 0-3 and arrays 5-7 now store the cache lines belonging to way 0. (In the event spare arrays were not provided, it is noted that the cache would operate with one-less set-associativity while array 4 is non-operational.) For write operations or cache refills, the write data destined for way 0 is steered accordingly; the spare array 104 is written with the most significant (or the least significant) bits of the cache line, and arrays 0-3 and 5-7 are written with the remaining bits (properly ordered).

It is then assumed that way 0 has the requested cache line after array 4 of way 0 has been taken “off line” and the spare array 104 placed into use. The way select control signal selects the leftmost input of the set of inputs to multiplexers 106 (i.e., the data from way 0). However, the value of the multi-bit shift select control signal is such that multiplexers 108-7, 108-6 and 108-5 choose the data input corresponding to columns 7, 6 and 5 of the way select multiplexers. However, multiplexers 108-4, 108-3, 108-2, and 108-1 choose the data corresponding to column 3, 2, 1 and 0 of the way select multiplexers. Further, multiplexer 108-0 selects the data input corresponding to the spare array 104.

As will be appreciated from the above description, once array 4 completes its period in a non-operational mode, it can be returned to a normal operational mode. This may entail, for example, invalidating the cache lines of the spare array prior to changing the value of the multi-bit shift select control signal so that each multiplexer 108-7 through 108-0 selects the left sided inputs. That is, the spare array 104 can return to being a spare array until such time as it is used to replace another array taken out of operation.

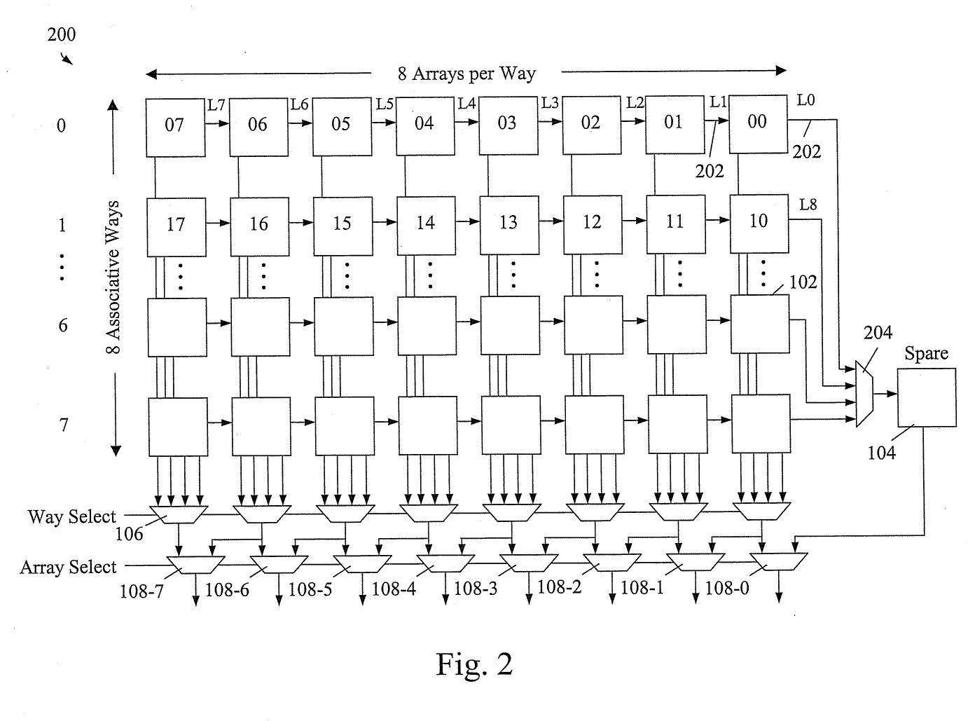

In the embodiment of FIG. 1, the use of the spare array 104 for a given one of the regular arrays 102 placed in a non-operational mode results in a data flushing operation to another level of cache prior to placing the array in a non-operational mode and the spare array 104 into an operational-mode. Once the spare array 104 is placed in the operational mode, it does not hold any valid data. A sequence of cache misses and cache reloads is required to populate the invalidated segment of the cache with data. Such reloads are usually triggered by cache misses, resulting in a considerable performance const of swapping the position of the array in the non-operation mode. In order to improve latency on this general approach, FIG. 2 is a schematic diagram of an alternative embodiment of the array structure of FIG. 1, further incorporating a data migration feature. More specifically, the memory array structure 200 of FIG. 2 incorporates (in addition to the features of FIG. 1) a plurality of dedicated, unidirectional dedicated links 202 to facilitate the migration of the contents of one array to an adjacent array. In FIG. 2, some of the dedicated links 202 are depicted with unique identifiers (e.g., L0, L1, L2, etc.) for illustrative purposes. In the case of the right most arrays of each way (i.e., array 00, 10, etc.), the data therein may each be selectively migrated to the spare array 104. Optionally, a multiplexer 204 may be used in conjunction with the links coming from 202 from right most arrays of each way.

By way of a further example, it is assumed that array 0 of way 0 (designated as array 00 in FIG. 2) is selected to enter a non-operational mode. The data stored in array 00 is then migrated to the spare array 104 through the dedicated link L0. In one embodiment, all cache lines are migrated without first looking up their state; alternatively, only valid cache lines are migrated by first checking their state. With the latter approach, the number of cache lines migrated may be reduced. On the other hand, this would use additional latency to read the directory or register file keeping the state of cache lines. Regardless, once the data migration from array 00 to the spare array 104 has been completed, array 00 enters its non-operational mode. During the migration, no directory access prevention mechanism is necessary and all cache lines in the cache, except for the way in which the array migration is in progress (e.g., way 0) are accessible. Thus, only those cache hits in the way where the array migration is in progress are delayed until migration is completed.

From this point, the spare array 104 and arrays 01 through 07 hold cache lines associated with way 0. In order to map in the spare array 104 and map out array 00 during the non-operational period for array 00, the way select and shift select control signals operate in the same manner as described above for the embodiment of FIG. 1.

Through the use of the dedicated links 202, it will further be appreciated that each successive array in way 0 could then have a turn at being placed in a non-operational mode. That is, once array 00 is returned to an operational state, array 01 can then be placed in a non-operational state, wherein the contents of array 01 are first migrated over the newly activated array 00. The original contents of array 00 would remain in the spare array 104. Again, the value of the multi-bit shift select control signal would be changed to reflect this new mapping. As this rotation process proceeds to the point where array 07 is the current array that is non-operational, the spare array 104 and arrays 00 through 06 now contain the cache lines associated with way 0.

However, if at this point it is further desired to continue to place additional ways (e.g., array 10 of way 1) into a non-operational mode, due to the unidirectional aspect of the links (which saves wiring), the cache lines stored in the spare array cannot be migrated back to the arrays of way 0. Thus, the cache lines of way 0 would need to be invalidated prior to data migration of array 10 into the spare array. Then, cache lines of array 10 are migrated to the spare array 104 through the dedicated link L8 so that array 10 may enter its non-operational mode.

In the event it is desired to completely avoid cache invalidation prior rotating non-operational arrays to different ways, then bi-directional links may be used for cache migration. Other configurations of links between arrays are also possible, such as one that connects all the arrays into a single one-way ring, including the spare array, or a combination of multiple complete or broken rings. The advantage of improved latency in this case would then be traded off for additional wiring real estate.

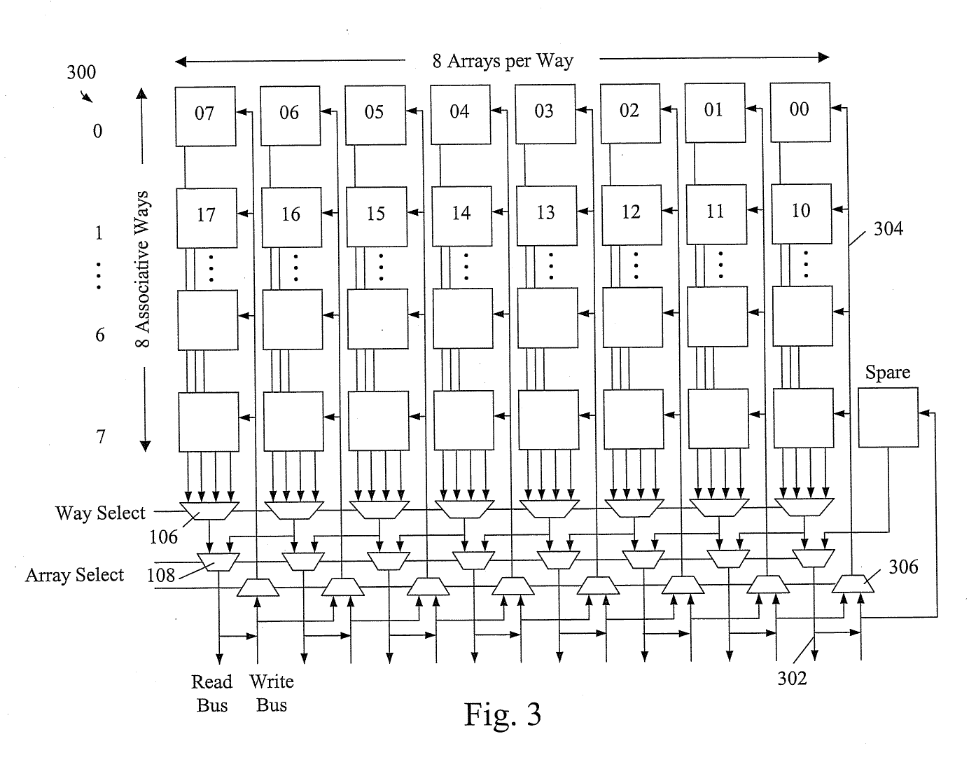

FIG. 3 is a schematic diagram of an alternative embodiment of the array structure of FIG. 2. In lieu of using separate, dedicated links for cache migration, the memory array structure 300 of FIG. 3 utilizes an existing read and write bus 302, 304, respectively to implement the cache migration. Each write bus 304 corresponding to a given array column may thus be used for a normal write operation or to migrate data from an adjacent array in the way. To implement this function, another level of multiplexers 306 is used to select between the nominal write bus data path and an adjacent write bus data path (with the exception of the leftmost multiplexer 306). As will be noted, the embodiment of FIG. 3 provides a bi-directional link, in that data from (for example, array 00) can be migrated into the spare array by reading it out on the read bus for array 00 and shifting it to the write bus of the spare array. Conversely, data in the spare array can be migrated back into array 00 since it can be read on the read bus for array 00 and then directed back to the write bus for array 00 through the associated multiplexer 306.

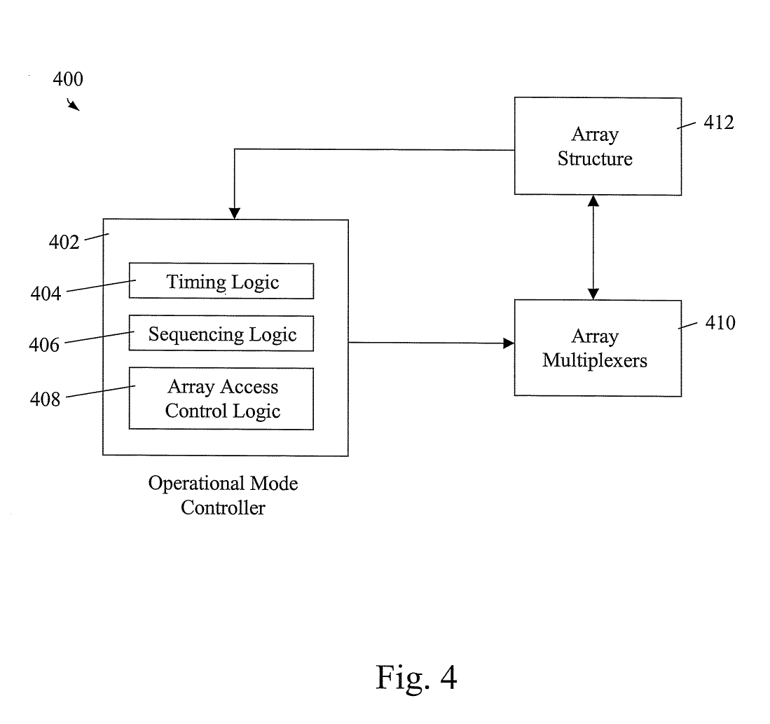

With respect to controlling which of the specific arrays are to be placed in the non-operational mode versus the operational mode, several approaches are contemplated. For example, FIG. 4 is a schematic block diagram of an exemplary control scheme 400 for sequencing individual arrays placed in the non-operational mode of operation. The exemplary control scheme 400 included an array operational mode controller 402, which controls which of the arrays in the cache are in an operational or a non-operational mode. The array operational mode controller 402 may further include, for example, timing logic 404, sequencing logic 406 and array access control logic as described below.

The timing logic 404 counts the number of cycles that an array that is currently in the non-operational mode has been in the non-operational mode, and optionally for each of the arrays in the operational mode, the number of cycles each has been in the operational mode since the last time they were in the non-operational mode. The timing logic 404 compares the counters with predetermined threshold values, and whenever the counter value exceeds the corresponding threshold, the timing logic 402 sends a signal to the sequencing logic 406, requesting that a new array be placed in the non-operational mode. Such threshold values may be either hard-wired in logic, set during system installation, set based on the monitoring of the error rate (for example, using error checking and correcting (ECC)), or set programmably by system software or firmware, such as a hypervisor.

The sequencing logic 406 keeps track of the sequence in which arrays enter the non-operational mode. One simple selection algorithm in this regard is a round-robin algorithm, implemented in a manner such that when all arrays enter the non-operational mode in a predefined circular order (such as row 0 from left right, then row 1 from left to right, and so on, for all rows, then the redundant array, then back to the leftmost array in row 0, and so on). Where links are implemented between arrays (e.g., FIG. 2, FIG. 3), then the sequence should be consistent with the direction of the links implemented, so as to allow data to be migrated through the link from array selected to enter to the non-operational mode next to migrate to the array that has just returned from the non-operational mode to the operational mode.

A more complicated algorithm for the selection may take into account the error rates from the arrays in the operational mode to give priority to the arrays showing the higher rate of errors. Upon receiving a signal from the timing logic 404, the sequencing logic 406 selects the next array to enter the non-operational mode. Second, the sequencing logic 406 triggers a sequence of steps so to bring the array that is currently in the non-operational mode to the operational mode (which may require a number of cycles to allow the complete discharge of the virtual ground). Third, the sequencing logic 406 triggers a sequence of steps needed to flush the data from the array that is selected to enter the non-operational mode, or move the date through the links between the two arrays (for those embodiments that implement the links). Fourth, the sequencing logic 406 triggers a sequence of steps needed to place the selected array to the non-operational mode. This process may require the writing of the special pattern of logical ones and zeros, and then asserting the values on the signals that control the mode of operation of the array.

Finally, the array access control logic 408 communicates the appropriate control signals to the array multiplexers 410 that actually shift the data within the given array structure 412. As will thus be appreciated, the operational mode controller 402 is enables proactive action by placing the arrays into non-operational mode before an hard error occurs, such as one resulting from a cell losing its read stability (in contrast to conventional techniques that take an array off line permanently, only after a hard error has already been detected). Furthermore, any array placed in the non-operational mode is returned to the operational mode once the recovery/maintenance action is complete, as opposed to conventional techniques that take the failed array off line permanently.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for implementing dynamic redundancy for a microprocessor system, the method comprising:
selectively placing at least one of a plurality of microprocessor components in a non-operational mode while one or more other of the microprocessor components remain in an operational mode, and then subsequently restoring the at least one of a plurality of microprocessor components from the non-operational mode back to the operational mode, wherein the operational mode comprises the performance of one or more tasks for which the microprocessor component is designed to execute with respect to the microprocessor system;
switching a spare microprocessor component from the non-operational mode to the operational mode whenever one of the plurality of the microprocessor components is placed in the non-operational mode, and wherein the spare microprocessor component is configured to be switched back to the non-operational mode whenever each of the microprocessor components are in the operational mode; and
mapping, through multiplexing circuitry, the use of the microprocessor components and the spare microprocessor component with respect to the operational mode and the non-operational mode;
wherein the non-operational mode comprises a process designed to reverse aging mechanisms of transistor devices included in the plurality of microprocessor components, the aging mechanisms including one or more of: negative bias temperature instability (NBTI), positive bias temperature instability (PBTI), and time dependent dielectric breakdown (TDDB).

2. The method of claim 1, wherein the plurality of microprocessor components further comprises individual memory arrays defining a set-associative cache; and the spare microprocessor component comprises a spare memory array.

3. The method of claim 2, further comprising utilizing at least one data communication link associated with each of the memory arrays and the spare array so as to facilitate a data migration from a selected array for the non-operational mode to another array prior to placing the selected array in the non-operational mode, thereby avoiding a cache line invalidation operation for the selected array.

4. The method of claim 3, wherein the at least one data communication link comprises one of the following:
a dedicated connection from array to array; and
an existing read and write bus structure associated with the cache.

5. The method of claim 1, further comprising selecting microprocessor components to be placed in the non-operational mode based on error rates thereof while in the operational mode.
